(19) United States
(12) Patent Application Publication
(10) Pub. No.: US 2021/0295258 A1
(43) Pub. Date: Sep. 23, 2021

(54) DELIVERY SYSTEM

(71) Applicant: HONDA MOTOR CO., LTD., Tokyo (JP)

(72) Inventor: Ryo TAKEBAYASHI, WAKO-SHI (JP)

(21) Appl. No.: 16/821,252

(22) Filed: Mar. 17, 2020

(51) Int. Cl. G06Q 10/08; G08G 1/00; G06K 9/00; G08G 1/0967

(52) U.S. Cl. CPC G06Q 10/0836; G06Q 10/0833; G08G 1/096708; G08G 1/205; G06K 9/00791; G06Q 10/0832

(57) ABSTRACT

A delivery system is equipped with a vehicle, a customer terminal that is operable by a recipient of a parcel, a carrier terminal possessed by a carrier of the parcel, and a server that transmits information to the carrier terminal indicating the vehicle as a delivery destination of the parcel, in the case of receiving information from the customer terminal specifying the vehicle as a reception location for the parcel, wherein the delivery system further comprises an insect repelling control unit which performs an insect repelling control in order to prevent insects from entering into an interior of the vehicle due to accommodation of the parcel in the vehicle at a delivery date and time of the parcel.

### BACKGROUND OF THE INVENTION

### Field of the Invention

The present invention relates to a delivery system by which a delivery person delivers a parcel to a vehicle.

### Description of the Related Art

In Japanese Laid-Open Patent Publication No. 2006-206225, a technique is disclosed in which the vehicle of a recipient is used as a reception location, in order to deliver a parcel even in the case that the recipient of the parcel is absent. In accordance with such a technique, the trunk of the vehicle is unlocked by performing mutual authentication between a communication device of a delivery person and the vehicle for receiving the parcel. According to the technique disclosed in Japanese Laid-Open Patent Publication No. 2006-206225, the delivery person can deliver the parcel to the vehicle regardless of the presence or absence of the recipient.

### SUMMARY OF THE INVENTION

Vehicles are sometimes parked in locations where an amount of floating or airborne insects is high. In this case, when the delivery person accommodates the parcel in the vehicle, there is a concern that insects may enter into the vehicle. In the case that insects enter into the vehicle, the recipient will experience a sense of discomfort.

The present invention has been devised taking into consideration the aforementioned problems, and has the object of providing a delivery system that is capable of reducing the amount of insects that enter into a vehicle.

An aspect of the present invention is characterized by a delivery system, comprising a vehicle, a customer terminal configured to be operable by a recipient of a parcel, a carrier terminal possessed by a carrier of the parcel, and a server configured to transmit information to the carrier terminal indicating the vehicle as a delivery destination of the parcel, in the case of receiving information from the customer terminal specifying the vehicle as a reception location for the parcel, wherein the delivery system further comprises an insect repelling control unit configured to perform an insect repelling control in order to prevent insects from entering into an interior of the vehicle due to accommodation of the parcel in the vehicle at a delivery date and time of the parcel.

According to the present invention, the amount of insects that enter into the vehicle can be reduced.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a diagram showing the configuration of a delivery system according to a first embodiment;

FIG. 2 is a functional block diagram showing the configuration of a delivery server;

FIG. 3 is a functional block diagram showing the configuration of a vehicle;

FIG. 4 is a sequence diagram showing a pre-delivery process;

FIG. 5 is a diagram showing the flow of an insect countermeasure process;

FIG. 6 is a sequence diagram showing a first prediction process;

FIG. 7 is a sequence diagram showing a first insect repelling process;

FIG. 8 is a diagram showing the configurations of delivery systems according to a second embodiment and a third embodiment;

FIG. 9 is a sequence diagram showing a second prediction process;

FIG. 10 is a sequence diagram showing a second insect repelling process; and

FIG. 11 is a sequence diagram showing a third insect repelling process.

### DESCRIPTION OF THE PREFERRED EMBODIMENTS

Preferred embodiments of a delivery system according to the present invention will be presented and described in detail below with reference to the accompanying drawings.

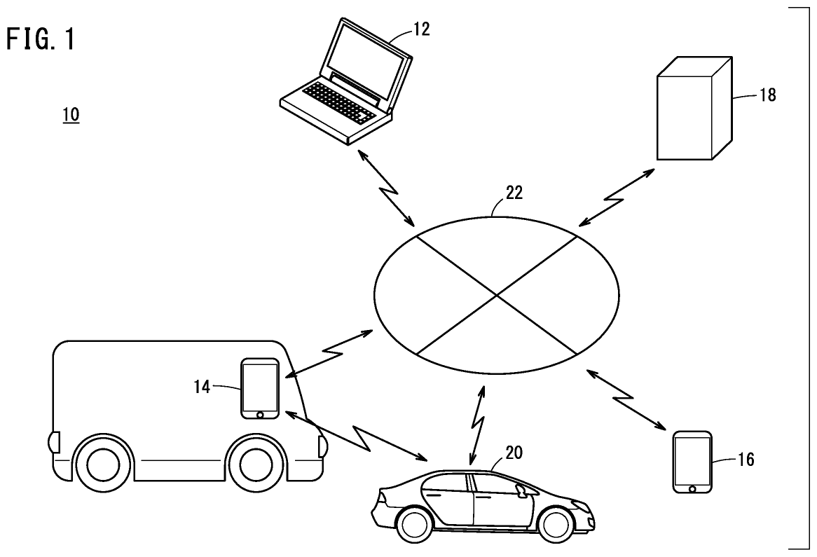

The delivery system 10 according to the present invention is used for a vehicle delivery service provided by a courier. The vehicle delivery service is a service in which a delivery person delivers a parcel to a vehicle 20, in the case that a recipient of the parcel specifies the vehicle 20 (see FIG. 1, etc.) as a delivery location for the parcel. The recipient designates a trunk or a cabin of the vehicle 20 as a space (accommodation space) in which the parcel is to be accommodated. The delivery person accommodates the parcel in the accommodation space that was designated by the recipient.

### 1. First Embodiment

### [1.1. Configuration of Delivery System 10]

As shown in FIG. 1, the delivery system 10 is equipped with devices such as a provider terminal 12, a carrier terminal 14, a customer terminal 16, a delivery server 18, a vehicle 20, and the like. The respective devices are capable of mutually transmitting and receiving information via an information communication network 22 such as the Internet.

### [1.1.1. Provider Terminal 12, Carrier Terminal 14, Customer Terminal 16]

The provider terminal 12 is a device installed in an office or the like of a delivery company, and is constituted, for example, by a personal computer. The carrier terminal 14 is a device that is carried by the delivery person, and is constituted, for example, by a smartphone, a tablet, a laptop personal computer, a dedicated terminal, or the like. The customer terminal 16 is a device that can be operated by a customer who is a recipient of the parcel, and is configured, for example, by a personal computer, a smartphone, a tablet, or a laptop personal computer.

### [1.1.2. Delivery Server 18]

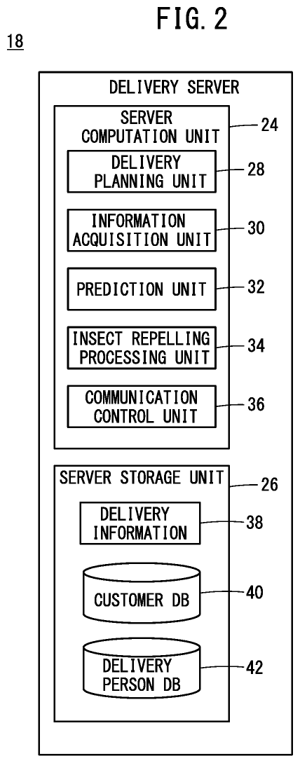

The delivery server 18 is a device that is used by the delivery company, and is constituted by a computer. As shown in FIG. 2, the delivery server 18 includes a server computation unit 24 including a processor, a server storage unit 26 having a RAM and a ROM, etc., a non-illustrated input/output device, a communications interface, and the like.

The server computation unit 24, by programs being executed by the processor, functions as a delivery planning unit 28, an information acquisition unit 30, a prediction unit 32, an insect repelling processing unit 34, and a communication control unit 36. The delivery planning unit 28 makes a delivery plan for delivery of the parcel. For example, the delivery planning unit 28 determines a delivery date and time and a delivery person for the parcel, on the basis of information transmitted from the provider terminal 12, information stored in a later-described delivery person database 42, and information transmitted from the customer terminal 16. The information acquisition unit 30 acquires various types of information transmitted from the exterior. The prediction unit 32 predicts an amount of insects that are floating or airborne in the vicinity of the vehicle 20 at the delivery date and time. The insect repelling processing unit 34 performs the insect repelling process on the delivery date and time that the parcel is delivered. The insect repelling process is a process which is performed in order to prevent insects from entering into the vehicle 20 due to the parcel being accommodated in the vehicle 20. The communication control unit 36 transmits various information to each of the devices.

The server storage unit 26 stores delivery information 38 in addition to various programs. The delivery information 38 is information created for each delivery, and is created at a stage that a delivery to the vehicle 20 is determined. The delivery information 38 includes the delivery date and time, the contents of the delivery, the name of the recipient (customer), information of the vehicle 20 (referred to as vehicle information) that serves as the delivery destination, and the like. The vehicle information includes information such as identifying information of the vehicle 20 (the vehicle type and number, etc.), a parking location of the vehicle 20, a designated accommodation space (a trunk or a cabin), and the like.

Further, in the server storage unit 26, a customer database 40 (referred to as a customer DB 40) and a delivery person database 42 (referred to as a delivery person DB 42) are created. The customer DB 40 stores information of customers (referred to as customer information) who can receive the vehicle delivery service. The customer information includes information such as the address, the name, the contact address (such as a telephone number and an email address or the like), the vehicle information, and the like. On the other hand, the delivery person DB 42 stores information of delivery persons (referred to as delivery person information). The delivery person information includes information such as the name, a delivery person number, a work schedule of the delivery person, and the like.

### [1.1.3. Vehicle 20]

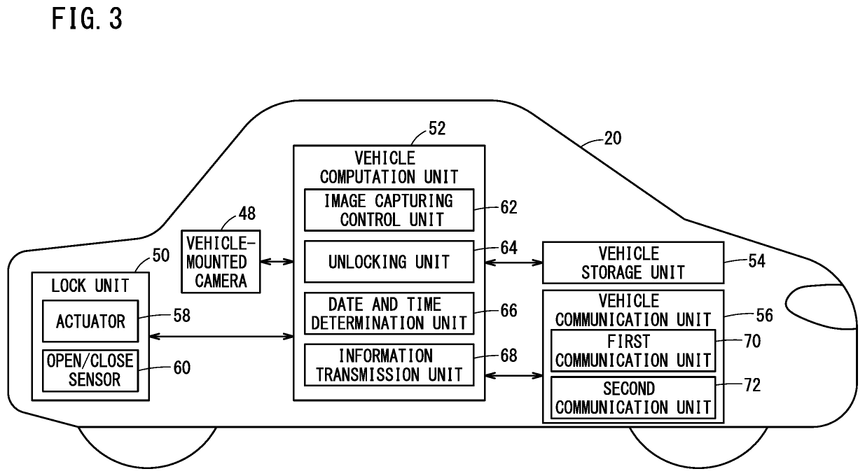

The vehicle 20 is parked in a specified location (a parking location for the vehicle 20 stored in the customer DB 40) at the delivery date and time. As shown in FIG. 3, the vehicle 20 is equipped with a vehicle-mounted camera 48, a lock unit 50, a vehicle computation unit 52, a vehicle storage unit 54, a vehicle communication unit 56, and the like.

The vehicle-mounted camera 48 is arranged at a position where an image can be captured of the exterior of the vehicle 20, and preferably, where an image of the periphery of the accommodation space can be captured. The vehicle-mounted camera 48 may be an infrared camera that is capable of capturing images even when the surrounding vicinity of the vehicle 20 is dark, or may be a camera that operates in conjunction with lighting (not shown). In the first embodiment, the vehicle-mounted camera 48 captures a still image, however, a moving image may also be captured.

The lock unit 50 is a device that locks or unlocks a lock of a door that opens and closes the accommodation space. The lock unit 50 is equipped with an actuator 58 that switches between a locked state and an unlocked state of the lock, a drive circuit (not shown) that drives the actuator 58, an open/close sensor 60 that detects an opened or closed state of the door provided at the entrance to the accommodation space, and the like. In the case that the accommodation space is the cabin, the lock unit 50 switches between a locked state and an unlocked state of the door lock. In the case that the accommodation space is the trunk, the lock unit 50 switches between a locked state and an unlocked state of a lock for the trunk lid.

The vehicle computation unit 52 includes a processor. By the processor executing programs, the vehicle computation unit 52 functions as an image capturing control unit 62, an unlocking unit 64, a date and time determination unit 66, and an information transmission unit 68. The image capturing control unit 62 controls an image capturing operation of the vehicle-mounted camera 48, and causes the vehicle storage unit 54 to temporarily store image information acquired by the vehicle-mounted camera 48. The unlocking unit 64 unlocks the lock of the lock unit 50. The date and time determination unit 66 determines the date and time on the basis of a system calendar. The information transmission unit 68 transmits various types of information to the exterior via the vehicle communication unit 56.

The vehicle storage unit 54 includes a RAM and a ROM or the like. In addition to various programs, the vehicle storage unit 54 stores a preset virtual key. The virtual key is defined by electronic information that is necessary in order to unlock the lock of the lock unit 50.

The vehicle communication unit 56 includes a first communication unit 70 for exchanging information with the carrier terminal 14, and a second communication unit 72 for exchanging information with respective devices via the information communication network 22. The first communication unit 70 utilizes a technique of short range wireless communications, such as infrared communications or Bluetooth (registered trademark). Each of the communication devices includes a communication circuit, an antenna, and the like.

### [1.2. Pre-Delivery Process]

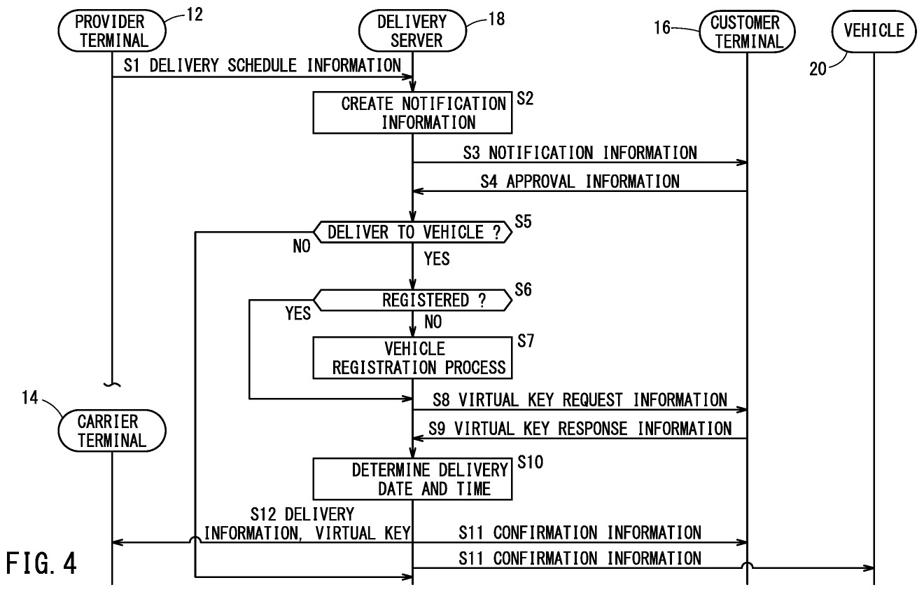

When the delivery request is generated, an operator of the delivery company operates the provider terminal 12 to thereby generate delivery schedule information. The delivery schedule information includes information such as the address of the recipient, the name of the recipient (customer), contact information (a telephone number, an email address, etc.) of the recipient, a scheduled delivery date and time, and the contents of the parcel. When the delivery schedule information is generated, the process proceeds according to the procedure shown in FIG. 4.

In step S1, the provider terminal 12 transmits the generated delivery schedule information to the delivery server 18.

In step S2, the delivery planning unit 28 of the delivery server 18 creates notification information on the basis of the delivery schedule information. The notification information includes, in addition to information such as the scheduled delivery date and time and the contents of the delivery and the like, an inquiry as to whether or not the delivery destination is the vehicle 20.

In step S3, the communication control unit 36 transmits the notification information to the customer terminal 16. The communication control unit 36 sets the email address of the recipient included in the delivery schedule information as a transmission destination of the notification information. Alternatively, the communication control unit 36 may search for the recipient information from within the customer DB 40, and may use an email address included within the searched information as the transmission destination of the notification information.

In step S4, the customer terminal 16 replies or transmits back approval information to the delivery server 18. The approval information is transmitted back in the case that the recipient approves of the scheduled delivery date and time. Moreover, although not illustrated, in the case that the recipient does not approve of the scheduled delivery date and time, the customer terminal 16 transmits back non-approval information to the delivery server 18. In this case, the processes of step S2 and step S3 are performed again. The delivery planning unit 28 proposes another delivery date and time. The approval information includes, in addition to the information indicating the intention of the approval, a response made with respect to the inquiry included in the notification information (whether or not the delivery destination is the vehicle 20).

In step S5, the delivery planning unit 28 determines whether or not to deliver the parcel to the vehicle 20 on the basis of the approval information. In the case of delivering to the vehicle 20 (step S5: YES), the process proceeds to step S6. On the other hand, in the case of not delivering to the vehicle 20 (step S5: NO), the pre-delivery process is brought to an end. In this case, the delivery person does not deliver the parcel to the vehicle 20, but delivers the parcel to the address of the recipient included in the delivery schedule information.

In step S6, the delivery planning unit 28 determines whether or not the vehicle information is registered in the information of the recipient that is stored in the customer DB 40. In the case of being registered (step S6: YES), the process proceeds to step S8. On the other hand, in the case of not being registered (step S6: NO), the process proceeds to step S7.

In step S7, a vehicle registration process is performed. Although not illustrated, the communication control unit 36 transmits guidance information to facilitate registration of the vehicle to the customer terminal 16. In the case that the customer terminal 16 replies with the vehicle information, the delivery planning unit 28 registers the vehicle information in the customer DB 40. Moreover, in the case that the customer terminal 16 does not reply with the vehicle information, the pre-delivery process is brought to an end. In this case, the delivery person does not deliver the parcel to the vehicle 20, but delivers the parcel to the address of the recipient included in the delivery schedule information.

In step S8, the communication control unit 36 transmits virtual key request information to the customer terminal 16. The virtual key request information is an inquiry concerning a virtual key made with respect to the customer terminal 16 from the delivery server 18.

In step S9, the customer terminal 16 transmits virtual key response information to the delivery server 18. The virtual key response information is information concerning the virtual key.

In step S10, the delivery planning unit 28 determines the scheduled delivery date and time approved by the recipient as the official delivery date and time. Furthermore, the communication control unit 36 creates delivery information 38.

In step S11, the communication control unit 36 transmits confirmation information to the customer terminal 16 and the vehicle 20. The confirmation information includes information such as the delivery date and time, the contents of the parcel, and the name of the delivery person and the like. The recipient verifies the confirmation information transmitted to the customer terminal 16, and parks the vehicle 20 in the registered parking location by the delivery date and time.

In step S12, the communication control unit 36 transmits the delivery information 38 and the virtual key to the carrier terminal 14. The delivery person verifies the delivery information 38 that was transmitted to the carrier terminal 14, and performs the delivery at the designated delivery date and time.

### [1.3. Insect Countermeasure Process]

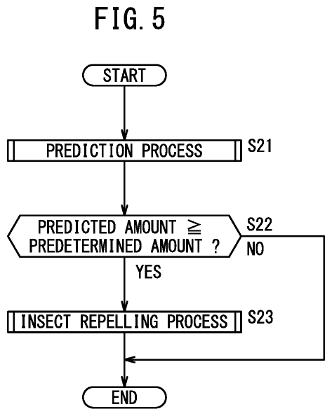

The insect countermeasure process shown in FIG. 5 is performed after the pre-delivery process illustrated in FIG. 4 has been completed, and more specifically, after the delivery date and time have been determined (after step S10).

In step S21, a device such as the delivery server 18 or the like performs a prediction process to predict the amount of insects floating in the vicinity of the vehicle 20 at the delivery date and time. The prediction process will be described later. After the process of step S21 has been executed, the process proceeds to step S22.

In step S22, the prediction unit 32 of the delivery server 18 compares the predicted amount of insects with a predetermined amount that was stored beforehand in the server storage unit 26. In the case that the predicted amount of insects is greater than or equal to the predetermined amount (step S22: YES), the process proceeds to step S23. On the other hand, in the case that the predicted amount of insects is less than the predetermined amount (step S22: NO), the insect countermeasure process is brought to an end. In this case, the amount of insects floating in the vicinity of the vehicle 20 is small, and the possibility of insects entering into the accommodation space of the vehicle 20 is low. Therefore, the insect repelling process is not performed.

In step S23, a device such as the delivery server 18 or the like performs the insect repelling process. The insect repelling process will be described later. After the process of step S23 has been executed, the insect countermeasure process is brought to an end.

### [1.4 First Insect Prediction Process]

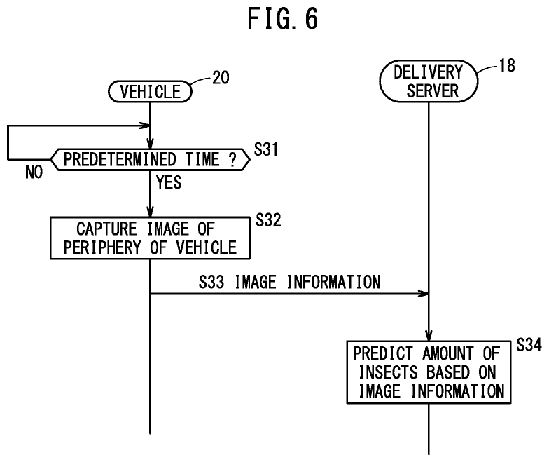

As an example of the prediction process performed in step S21 of FIG. 5, the first prediction process shown in FIG. 6 will be described.

In step S31, the date and time determination unit 66 of the vehicle 20 determines whether or not a predetermined time has arrived. The predetermined time is defined as a time that an image of the periphery of the vehicle 20 is captured, and is a time that is a fixed time period prior to the delivery date and time. The fixed time period is stored in the vehicle storage unit 54 in advance. In the case that the predetermined time has arrived (step S31: YES), the process proceeds to step S32. On the other hand, in the case that the predetermined time has not arrived (step S31: NO), the process of step S31 is performed repeatedly.

In step S32, the image capturing control unit 62 of the vehicle 20 outputs an image capturing signal to the vehicle-mounted camera 48. The vehicle-mounted camera 48 captures an image of the periphery of the vehicle 20 in accordance with the image capturing signal. The image capturing control unit 62 causes the vehicle storage unit 54 to temporarily store image information acquired by the vehicle-mounted camera 48. In this instance, the stored image information indicates the situation in the vicinity of the vehicle 20. After the process of step S32 has been executed, the process proceeds to step S33.

In step S33, the information transmission unit 68 transmits the image information to the delivery server 18. The information acquisition unit 30 of the delivery server 18 acquires the image information transmitted from the vehicle 20, and stores the image information in the server storage unit 26. After the process of step S33 has been executed, the process proceeds to step S34.

In step S34, the prediction unit 32 of the delivery server 18 predicts the amount of insects on the basis of the image information. For example, the prediction unit 32 carries out image recognition, and detects the insects included within the image, together with counting the number of insects. In addition, the prediction unit 32 uses the counted number of insects as a predicted amount of insects floating externally of the vehicle 20 at the delivery date and time. After the process of step S34 has been executed, the process proceeds to step S22 of FIG. 5.

### [1.5. First Insect Repelling Process]

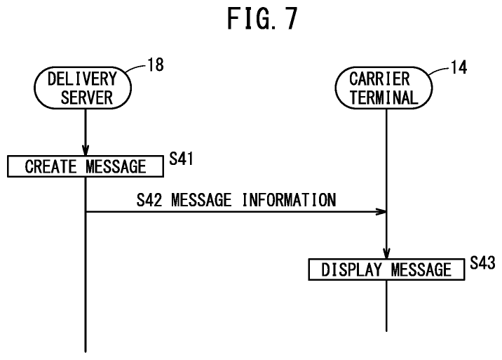

As an example of the insect repelling process performed in step S23 of FIG. 5, the first insect repelling process shown in FIG. 7 will be described. In the first insect repelling process, the insect repelling processing unit 34 and the communication control unit 36 function as the insect repelling control unit of the delivery server 18.

In step S41, the insect repelling processing unit 34 of the delivery server 18 creates a message to be transmitted to the carrier terminal 14. The message includes a warning message urging caution in relation to insects entering into the vehicle 20. The message is stored in the server storage unit 26 in advance. After the process of step S41 has been executed, the process proceeds to step S42.

In step S42, the communication control unit 36 transmits a message to the carrier terminal 14. After the process of step S42 has been executed, the process proceeds to step S43.

In step S43, prior to the delivery date and time, the carrier terminal 14 displays a message on the display. By observing such a message, the delivery person recognizes that there is a possibility that insects may enter into the accommodation space of the vehicle 20. Therefore, the delivery person accommodates the parcel while taking care not to allow the insects to enter into the accommodation space. As a result, the amount of insects that enter into the accommodation space of the vehicle 20 is small.

### 2. Second Embodiment

The first embodiment and the second embodiment coincide with one another in many respects. Hereinafter, a description will be given of the portions of the second embodiment that differ from the first embodiment. In the second embodiment, constituent elements that are common with the first embodiment are denoted by the same reference numerals.

### [2.1. Configuration of Delivery System 10]

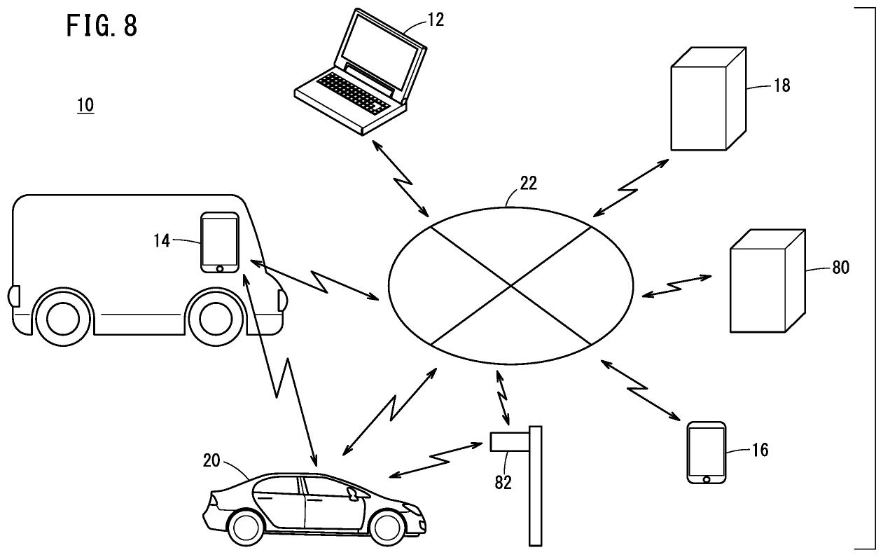

As shown in FIG. 8, the delivery system 10 is equipped with devices such as the provider terminal 12, the customer terminal 16, the carrier terminal 14, the delivery server 18, the vehicle 20, a weather information server 80, an electric lamp 82, and the like. The respective devices are capable of mutually transmitting and receiving information via the information communication network 22.

### [2.1.1. Delivery Server 18]

The configuration of the delivery server 18 of the second embodiment is the same as the configuration of the delivery server 18 of the first embodiment. Moreover, in the second embodiment, the server storage unit 26 stores a prediction model that associates weather conditions with the amount of insects at each of respective locations. As the prediction model, an existing model of a time series analysis, for example, a multiple regressive or an autoregressive moving average (ARIMA) or the like is used.

### [2.1.2. Vehicle 20]

The vehicle 20 is parked in a specified location (a parking location for the vehicle 20 stored in the customer DB 40) at the delivery date and time. It should be noted that, according to the second embodiment, an image of the vicinity of the vehicle 20 is not used. Therefore, there is no need for the vehicle 20 to be equipped with the vehicle-mounted camera 48 shown in FIG. 3.

### [2.1.3. Weather Information Server 80]

The weather information server 80 is a device that is used by a provider that provides weather information, and is constituted by a computer. The weather information server 80 transmits to respective devices weather information indicative of local weather forecasts for each of respective regions.

### [2.1.4. Electric Lamp 82]

The electric lamp 82 is a lighting device installed in the vicinity of the parking location of the vehicle 20, and is a street lamp, an outdoor lamp of a building, the headlights of another vehicle, a moth lamp, or the like.

### [2.2. Pre-Delivery Process]

Similar to the first embodiment, the pre-delivery process shown in FIG. 4 is also performed in the second embodiment.

### [2.3. Insect Countermeasure Process]

Similar to the first embodiment, the insect countermeasure process shown in FIG. 5 is also performed in the second embodiment.

### [2.4 Second Insect Prediction Process]

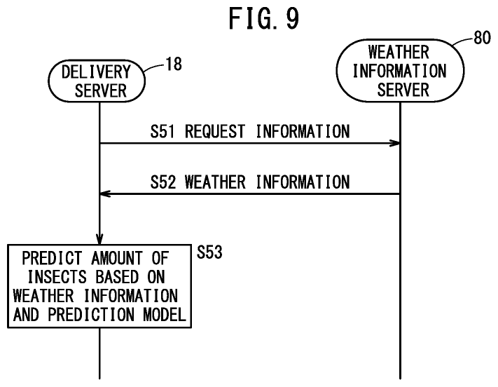

As an example of the prediction process performed in step S21 of FIG. 5, the second prediction process shown in FIG. 9 will be described.

In step S51, the communication control unit 36 of the delivery server 18 transmits request information to the weather information server 80. The request information includes a delivery date and time and information concerning the parking location of the vehicle 20. After the process of step S51 has been executed, the process proceeds to step S52.

In step S52, the weather information server 80 transmits back the weather information to the delivery server 18 corresponding to the request information. The weather information transmitted back in this instance includes weather forecast information of the parking location of the vehicle 20 at the delivery date and time. The information acquisition unit 30 of the delivery server 18 acquires the weather information transmitted from the weather information server 80, and stores the weather information in the server storage unit 26. After the process of step S52 has been executed, the process proceeds to step S53.

In step S53, the prediction unit 32 of the delivery server 18 predicts the amount of insects on the basis of the parking location information of the vehicle 20 stored in the customer DB 40, the weather information, and the prediction model stored in the server storage unit 26. After the process of step S53 has been executed, the process proceeds to step S22 of FIG. 5.

### [2.5. Second Insect Repelling Process]

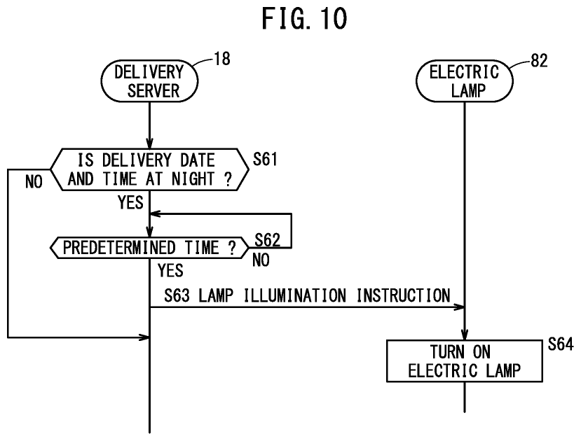

As an example of the insect repelling process performed in step S23 of FIG. 5, the second insect repelling process shown in FIG. 10 will be described. In the second insect repelling process, the insect repelling processing unit 34 and the communication control unit 36 function as the insect repelling control unit of the delivery server 18.

In step S61, the insect repelling processing unit 34 of the delivery server 18 determines whether or not the delivery date and time occurs within a dark time zone (at night) that is stored in the server storage unit 26. In the case that the delivery date and time is at night (step S61: YES), the process proceeds to step S62. On the other hand, in the case that the delivery date and time is not at night (step S61: NO), the second insect repelling process is brought to an end.

In step S62, the insect repelling processing unit 34 determines whether or not a predetermined time has arrived. The predetermined time is defined as a time when the electric lamp 82 is turned on, and is a time that is a fixed time period prior to the delivery date and time. The fixed time period is stored in the server storage unit 26 in advance. In the case that the predetermined time has arrived (step S62: YES), the process proceeds to step S63. On the other hand, in the case that the predetermined time has not arrived (step S62: NO), the process of step S62 is performed repeatedly.

In step S63, the communication control unit 36 of the delivery server 18 outputs a lamp illumination instruction to the electric lamp 82. After the process of step S63 has been executed, the process proceeds to step S64.

In step S64, the electric lamp 82 is turned on in response to the illumination instruction output from the delivery server 18. When the electric lamp 82 is turned on in a situation in which the surrounding periphery of the vehicle 20 is dark, the insects gather at the electric lamp 82. As a result, the number of insects floating in the vicinity of the vehicle 20 decreases, and the amount of insects that enter into the accommodation space of the vehicle 20 becomes small.

### 3. Third Embodiment

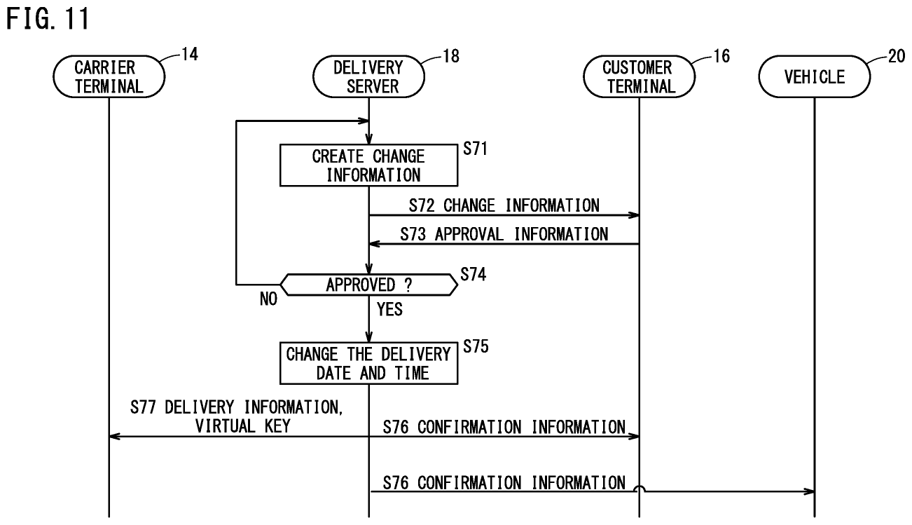

In the third embodiment, a third insect repelling process shown in FIG. 11 is carried out instead of the second insect repelling process according to the second embodiment (see FIG. 10). Hereinafter, the third insect repelling process will be described. In the third insect repelling process, the information acquisition unit 30, the prediction unit 32, the insect repelling processing unit 34, and the communication control unit 36 function as the insect repelling control unit of the delivery server 18.

In step S71, the insect repelling processing unit 34 of the delivery server 18 creates information concerning a change. The information concerning the change is information in order to propose to the recipient a change in the delivery date and time, and includes an alternative date and time for the delivery date and time. For example, the insect repelling processing unit 34 determines the alternative date and time for the delivery date and time in the following manner. At first, the insect repelling processing unit 34 proposes a predetermined time before or a predetermined time after the delivery date and time as an alternative candidate date and time. Next, processes similar to the processes of steps S51 and S52 are carried out with respect to the alternative candidate date and time, and the amount of insects at the alternative candidate date and time is predicted. In addition, in the case that the predicted amount of insects is less than the predetermined amount, the insect repelling processing unit 34 determines the alternative candidate date and time as an official alternative date and time. After the process of step S71 has been executed, the process proceeds to step S72.

In step S72, the communication control unit 36 transmits the information concerning the change to the customer terminal 16. After the process of step S72 has been executed, the process proceeds to step S73.

In step S73, the customer terminal 16 transmits back approval information to the delivery server 18. The approval information is transmitted back in the case that the recipient approves of the alternative delivery date and time. After the process of step S73 has been executed, the process proceeds to step S74.

In step S74, the insect repelling processing unit 34 determines whether or not the approval information has been acquired. In the case that the approval information has been acquired (step S74: YES), the process proceeds to step S75. On the other hand, in the case that the approval information has not been acquired (step S74: NO), the process returns to step S71. In this case, the insect repelling processing unit 34 proposes a predetermined time before or a predetermined time after the alternative date and time as a new alternative candidate date and time.

In step S75, the insect repelling processing unit 34 determines the alternative date and time approved by the recipient as the official delivery date and time. Furthermore, the communication control unit 36 creates the confirmation information. After the process of step S75 has been executed, the process proceeds to step S76 and step S77.

In step S76, the communication control unit 36 transmits the confirmation information to the customer terminal 16 and the vehicle 20. The confirmation information includes information such as the delivery date and time, the contents of the parcel, and the name of the delivery person and the like.

In step S77, the communication control unit 36 transmits the delivery information 38 after having been changed, and the virtual key to the carrier terminal 14. The delivery person verifies the delivery information 38 that was transmitted to the carrier terminal 14, and performs the delivery at the designated delivery date and time.

### 4. Modifications

One of the prediction processes (first and second prediction processes) performed in the first to third embodiments may be appropriately combined with one of the insect repelling processes (first to third insect repelling processes).

The carrier may be a drone instead of a delivery person. More specifically, the present invention can also be used in a system in which delivery of the parcel is performed by a drone.

As another embodiment, the vehicle 20 may be made to move to a location other than the parking location on the delivery date and time. In this case, the vehicle 20 measures by the positioning device the position of the parking location after having been moved, and transmits the position information to the delivery server 18. The delivery server 18 transmits the position information of the parking location after having been moved to the carrier terminal 14.

### 5. Technical Concepts Obtained from the Embodiments

Technical concepts that can be grasped from the above-described embodiments will be described below.

An aspect of the present invention is characterized by the delivery system 10 comprising the vehicle 20, the customer terminal 16 that is operable by a recipient of a parcel, the carrier terminal 14 possessed by the carrier of the parcel, and the server (delivery server 18) which transmits information to the carrier terminal 14 indicating the vehicle 20 as the delivery destination of the parcel, in the case of receiving information from the customer terminal 16 specifying the vehicle 20 as the reception location for the parcel, wherein the delivery system 10 further comprises the insect repelling control unit (the information acquisition unit 30, the prediction unit 32, the insect repelling processing unit 34, and the communication control unit 36) that performs the insect repelling control in order to prevent insects from entering into the interior of the vehicle 20 due to accommodation of the parcel in the vehicle 20 at a delivery date and time of the parcel.

In accordance with the above-described configuration, since the insect repelling control is performed at the delivery date and time of the parcel, the amount of insects that enter into the vehicle 20 can be reduced.

In the aforementioned aspect of the present invention, there may further be provided the prediction unit 32 that predicts the amount of insects floating in the vicinity of the vehicle 20 at the delivery date and time, wherein the insect repelling control unit (the information acquisition unit 30, the prediction unit 32, the insect repelling processing unit 34, and the communication control unit 36) may perform the insect repelling control, in the case that the amount of insects predicted by the prediction unit 32 is greater than or equal to a predetermined amount.

In accordance with the above-described configuration, since the insect repelling control is performed in the case that the amount of insects is greater than or equal to the predetermined amount, the insect repelling process can be performed only when necessary.

In the aforementioned aspect of the present invention, there may further be provided the information acquisition unit 30 that acquires image information indicative of an image captured at a predetermined time before the delivery date and time, wherein the prediction unit 32 may measure the amount of insects floating in the vicinity of the vehicle 20 on the basis of the image information, and may set the measurement result thereof as the amount of insects.

In the aforementioned aspect of the present invention, there may further be provided the storage unit (server storage unit 26) that stores a prediction model that associates weather conditions with the amount of insects at each of respective locations, and the information acquisition unit 30 that acquires weather information indicative of a weather forecast of a parking location for the vehicle at the delivery date and time, wherein the prediction unit 32 may predict the amount of insects on the basis of the weather information acquired by the information acquisition unit 30, and the prediction model stored in the storage unit.

In the aforementioned aspect of the present invention, as the insect repelling control, the insect repelling control unit (the insect repelling processing unit 34 and the communication control unit 36) may transmit to the carrier terminal 14 a message urging caution in relation to the insects entering into the vehicle 20.

In accordance with the above-described configuration, the delivery person who has been prompted to pay attention performs an operation so as to prevent insects from entering into the vehicle 20 when the parcel is accommodated in the vehicle 20. As a result, the amount of insects that enter into the vehicle 20 is reduced.

In the aforementioned aspect of the present invention, as the insect repelling control, the insect repelling control unit (the insect repelling processing unit 34 and the communication control unit 36) may turn on an electric lamp 82 existing within a predetermined range from the vehicle 20 before the delivery date and time.

In accordance with the above-described configuration, insects can be collected by the electric lamp 82 that is turned on, and the amount of insects floating in the vicinity of the vehicle 20 can be reduced. As a result, the amount of insects that enter into the vehicle 20 is reduced.

In the aforementioned aspect of the present invention, as the insect repelling control, the insect repelling control unit (the information acquisition unit 30, the prediction unit 32, the insect repelling processing unit 34, and the communication control unit 36) may cause the delivery date and time to be changed.

In accordance with the above-described configuration, the delivery date and time can be changed to a date and time at which the amount of insects is small. As a result, the amount of insects that enter into the vehicle 20 is reduced.

The delivery system according to the present invention is not limited to the embodiments described above, and it is a matter of course that various modified or additional configurations could be adopted therein without deviating from the essence and gist of the present invention.

What is claimed is:

1. A delivery system, comprising:
a vehicle;
a customer terminal configured to be operable by a recipient of a parcel;
a carrier terminal possessed by a carrier of the parcel; and
a server configured to transmit information to the carrier terminal indicating the vehicle as a delivery destination of the parcel, in a case of receiving information from the customer terminal specifying the vehicle as a reception location for the parcel;
wherein the delivery system further comprises an insect repelling control unit configured to perform an insect repelling control in order to prevent insects from entering into an interior of the vehicle due to accommodation of the parcel in the vehicle at a delivery date and time of the parcel.

2. The delivery system according to claim 1, further comprising:
a prediction unit configured to predict an amount of insects floating in a vicinity of the vehicle at the delivery date and time;
wherein the insect repelling control unit performs the insect repelling control, in a case that the amount of insects predicted by the prediction unit is greater than or equal to a predetermined amount.

3. The delivery system according to claim 2, further comprising:
an information acquisition unit configured to acquire image information indicative of an image captured at a predetermined time before the delivery date and time;
wherein the prediction unit measures the amount of insects floating in the vicinity of the vehicle on a basis of the image information, and sets a measurement result thereof as the amount of insects.

4. The delivery system according to claim 2, further comprising:
a storage unit configured to store a prediction model that associates weather conditions with the amount of insects at each of respective locations; and
an information acquisition unit configured to acquire weather information indicative of a weather forecast of a parking location for the vehicle at the delivery date and time;
wherein the prediction unit predicts the amount of insects on a basis of the weather information acquired by the information acquisition unit, and the prediction model stored in the storage unit.

5. The delivery system according to claim 1, wherein, as the insect repelling control, the insect repelling control unit transmits to the carrier terminal a message urging caution in relation to the insects entering into the vehicle.

6. The delivery system according to claim 1, wherein, as the insect repelling control, the insect repelling control unit turns on an electric lamp existing within a predetermined range from the vehicle before the delivery date and time.

7. The delivery system according to claim 1, wherein, as the insect repelling control, the insect repelling control unit causes the delivery date and time to be changed.
